(19) United States
(12) Patent Application Publication
(10) Pub. No.: US 2023/0410182 A1
(43) Pub. Date: Dec. 21, 2023

(54) SYSTEMS AND METHODS HANDLING MOBILE TECHNOLOGY COMMUNICATIONS

(71) Applicant: Qatchco, Inc., Boston, MA (US)

(72) Inventors: Nicole C. Phillips, Boston, MA (US); Raquel L. Phillips, Boston, MA (US); Ben Peleg, Boston, MA (US); Deep Bhanushali, Boston, MA (US); Rhohith Reddy Narra, Boston, MA (US)

(21) Appl. No.: 18/335,939

(22) Filed: Jun. 15, 2023

Related U.S. Application Data
(60) Provisional application No. 63/352,622, filed on Jun. 15, 2022.

(51) Int. Cl. G06Q 30/0601; G06Q 30/0203

(52) U.S. Cl. CPC G06Q 30/0631; G06Q 30/0203

(57) ABSTRACT

Systems and methods that communicate a user's explicit text, iMessage, or Tapback interaction made on one communication protocol or system (for instance, SMS) and reflects that interaction related to the same product hosted and presented on another system (for instance, a website). The systems and methods connect behavior occurring on two systems so that behavior is carried over from one to the other for the benefit of the end-user. Additionally, from the user interaction originating from SMS, further product recommendations may be generated based on any or all of: the specific user's interaction (for instance, a like or a love or other interaction); the product which received that interaction; additional products listed on a seller's Website; and information about the additional products.

### CROSS-REFERENCE TO RELATED APPLICATIONS

This application claims priority to U.S. Provisional Pat. Application No. 63/352,622 filed Jun. 15, 2022, the entirety of which is incorporated by reference.

### BACKGROUND OF THE DISCLOSURE

Increasingly, consumers are shopping for goods remotely, including, for example, fashion goods. Retailers, brands, and manufactures can provide online storefronts including through websites, social media experience, mobile applications and the like at which consumers can order goods. A consumer may have fashion preferences, which can include preferences for certain brands, styles, clothing types, designers, and the like. These preferences at least partially inform a consumer's decision to purchase one or more items remotely.

### SUMMARY OF THE DISCLOSURE

The disclosure includes a method for managing product recommendations for a user. The method includes receiving user data of a user of a product recommendation system, the user data including at least one style preference of the user. A first style bucket for the user is determined, the first style bucket being selected from a plurality of predefined style buckets based on the at least one style preference of the user. At least a first recommended product is selected from a plurality of products the first recommended product being selected based on one or more tags associated with the first recommended product, wherein at least one of the one or more tags is associated with the first style bucket. The first recommended product is added to a recommendation queue of the user. An instruction is generated to send a first recommendation message to the user, the recommendation message including at least one attribute of the first recommended product, wherein the first recommendation message is one of a simple messaging service (SMS) message or a multimedia messaging service (MMS) message. A first textual review associated with a first reaction message indicating a first reaction of the user to the first recommendation message is received, wherein the first reaction message is one of a simple messaging service (SMS) message or a multimedia messaging service (MMS) message. selecting At least a second recommended product is selected based at least in part on the first textual review. The second recommended product is added to the recommendation queue of the user.

### BRIEF DESCRIPTION OF THE SEVERAL VIEWS OF THE DRAWINGS

The disclosure can be more fully understood from the following detailed description taken in conjunction with the accompanying drawings, in which:

FIG. 1 is a system diagram illustrating aspects of a system for providing a personalized shopping experience for a user;

FIG. 2 is a schematic diagram illustrating aspects of a recommendation engine, according to some embodiments;

FIG. 3 is flowchart illustrating a process for tagging product inventory received from one or more sources, according to some embodiments, which can be implemented by the recommendation engines illustrated in FIGS. 1 and 2;

FIG. 4 is flowchart illustrating a process for recommending products to a user based on characteristics of a user, which can be implemented by the recommendation engines illustrated in FIGS. 1 and 2;

FIG. 5 is flowchart illustrating a process for communicating product recommendations to a user based on characteristics of a user, which can be implemented by the recommendation engines illustrated in FIGS. 1 and 2;

FIG. 6 is flowchart illustrating a process for selecting a recommendation model for a user, which can be implemented by the recommendation engines illustrated in FIGS. 1 and 2;

FIG. 7 is flowchart illustrating a process for recommending products for a user, which can be implemented by the recommendation engines illustrated in FIGS. 1 and 2; and

FIG. 8 is an example of hardware that can be used to implement a recommendation engine, according to some embodiments.

### DETAILED DESCRIPTION OF THE DISCLOSURE

For simplicity and illustrative purposes, the principles of the present disclosure are described by referring mainly to various exemplary embodiments thereof. Although preferred embodiments are particularly disclosed herein, one of ordinary skill in the art will readily recognize that the same principles are equally applicable to, and can be implemented in other systems, and that any such variation would be within such modifications that do not part from the true spirit and scope of the present disclosure. Before explaining the disclosed embodiments in detail, it is to be understood that disclosure is not limited in its application to the details of any particular arrangement shown. The terminology used herein is for the purpose of description and not of limitation.

As noted above, consumers are increasingly accessing online storefronts to shop for products. In some cases, online storefronts can be presented through a website that is accessible through a computer, a tablet, a mobile device (e.g., a smart watch), a head-mounted display (e.g., a virtual reality or augmented reality headset) or any other device capable of connecting to the internet. In some cases, products can be sold through applications developed for one or more operating systems (e.g., mobile operating systems, computer operating systems, HMD operating systems, and the like).

In selling products online, it can be valuable to have data for a consumer, to enable an online retailer or seller to tailor their inventory to a particular market, or to provide targeted marketing to individual consumers. For example, according to some aspects of this disclosure, as described below, user engagement data can be collected for a particular consumer or user of an online storefront, and that data can be processed and/or analyzed to determine a style preference for the user, which can, in turn, allow the operator of the storefront to market products to the user having a particular style. For example, if a user engages with dresses on an online storefront (e.g., by viewing dresses, buying dresses, reacting to dresses) the online storefront can be personalized for the consumer, so that, when the consumer visits the online storefront, the storefront presents other items similar or in the same style as the items the user previously engaged with (e.g., dresses).

Further, it can be advantageous for online retailers and sellers to market products to consumers through a variety of channels (e.g., through web advertisements, email messages, social media, and the like). According to this disclosure, messaging applications can be used to market to consumers, and data from the messaging software can be collected and used to determine product preferences (e.g., style preferences) to enable retailers and sellers to market products to the consumer that are tailored to the consumer's preferences. The present disclosure is related to systems and methods for using messaging applications to determine consumer style preferences.

For example, in one embodiment, a method involves the steps of sending a text or other form of message to a user and the user responding from their personal computing device such as a smartphone or PC. The user interaction message may include any of a number of responses, including an iMessage Tapback. Upon receipt of a user interaction message, for instance an SMS message, the system parses the message and updates one or more databases so that when the user accesses a website, the user may be identified, and the website is updated in a manner reflecting the user's interaction message. For instance, the website may display the user's prior interactions. So, for instance, a user may receive an SMS message showing a particular product from a seller, and the user responds sending an interaction such as a Tapback, or other interaction, for instance, indicating a “like” of the particular product, that user interaction is received by the system and added to a database along with an identifier for the user. When that user later visits the seller's website and is identified at the website, then the content displayed to the user may be customized for that user, for instance to show the user's prior interactions on the screen. The website may select and show only products for which the user previously provided an interaction, and/or the website may show a set of products determined based on other criteria and include an indication when the user had previously provided an interaction. The website may also be interactive with an underlying database so that interactions on the website can be combined with interactions received by SMS or other messaging.

The innovative methods described herein are based in part on handling messages generated and received using known messaging protocols such as SMS (Short Message Service) and MMS (Multimedia Messaging Service), as well as other available and future messaging protocols and it should be understood that as used herein message refers to any electronically generated digital content provided by or to a user using a client device that is configured to be transmitted and received over a communication channel to deliver or exchange content, images, text, numbers, symbols and other information as well as combinations thereof.

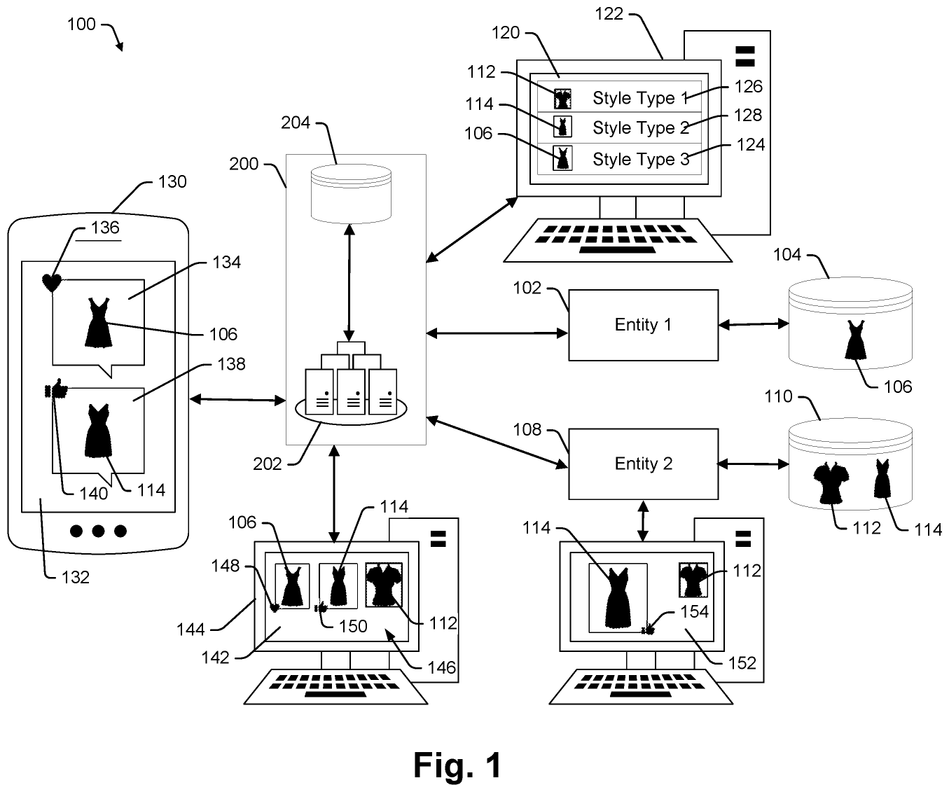

FIG. 1 illustrates an example system 100 for managing user style preferences using messaging applications (e.g., using text-to-web systems). As shown in FIG. 1, the system 100 can include a recommendation engine 200 for generating product recommendations for a user based on style preferences and engagement data from the user. The recommendation engine includes one or more computing systems 202 (e.g., servers, storage nodes, virtual servers, cloud computing services, and the like). The one or more computing systems can have programmed thereon (e.g., in a memory of one or more computers of the computing system) instructions for implementing one or more methods for providing product recommendations to a user. The recommendation engine 200 can further include one or more data stores 204 (e.g., a relational database, a non-relational database, an object storage system, a file storage system, and the like) in communication with the one or more computing systems 202 to store data related to recommended products and user interaction with the products.

The recommendation engine 200 can receive product data from one or more data sources, which can be owned or operated by one or more entities. The one or more data sources can include products which the recommendation engine can recommend to the user. For example, as shown, the recommendation engine can be in communication with a first entity 102 (e.g., an online retailer, seller, wholesaler, etc.), and can receive product inventory data from a data store 104 of the first entity 102 through a first interface 102. In some cases, the recommendation engine 200 can communicate with the first entity 102 using file transfer protocol (FTP) to pull product files and associated data from the data store 104. For example, in the illustrated embodiment, the data store 104 comprises a file system having a file including information of a first clothing item 106 (e.g., a dress). The recommendation engine 200 can query the data store 104 at an FTP interface of the first entity 102 and can receive one or more files and associated metadata with information on the first clothing item 106. In some cases, a data store can include a plurality of products, and the recommendation engine can query the data store through an interface to receive files and metadata associate with each of the plurality of products. In some embodiments, the data store can include a file server including a plurality of files. In some embodiments, a data store in communication with a recommendation engine can include any know data storage systems, including, for example, a relational database, a non-relational database, an object storage system, a storage associated with a server, and the like. In some cases, a recommendation engine can communicate with a data store to receive information about product inventory through any known communication protocol. For example, a recommendation engine can access a data store through an application programming interface (“API”), through hypertext transfer protocols (“HTTP/S”), through transmission control protocol (“TCP”), through user datagram protocol (“UDP”), through database protocols, and the like. Further, recommendation engines in accordance with this disclosure can receive products through a “pull” operation (e.g., the recommendation engine can query a data store including product inventory) or it can receive product inventory through a “push” operation (e.g., online sellers can initiate a communication of product inventory via an interface of the recommendation engine).

In some embodiments, a recommendation engine can access inventory from multiple distinct sources (e.g., from different data sources associated with distinct online sellers or brands). For example, FIG. 1 illustrates a second entity 108 which can provide an interface for the recommendation engine 200 to access product inventory stored in a second data store 110. The description of the first data store 104 can be applicable to the second data store 110. In the illustrated embodiment, a second clothing item 112 and a third clothing item 114 are shown in the second data store 110. While two clothing items 112, 114 are shown in the second data store, one of ordinary skill in the art would understand that a data store can include an unlimited number of products (e.g., clothing items) stored thereon, subject to storage constraints or other technical limitations of the data store. The recommendation engine 200 can query the second data store 110 through the interface provided by the second entity 108 to receive information (e.g., any combination of files, objects, database entries, metadata etc.) pertaining to the clothing items in the inventory stored on the second data store 108. the inventory (e.g., clothing items 112, 114).

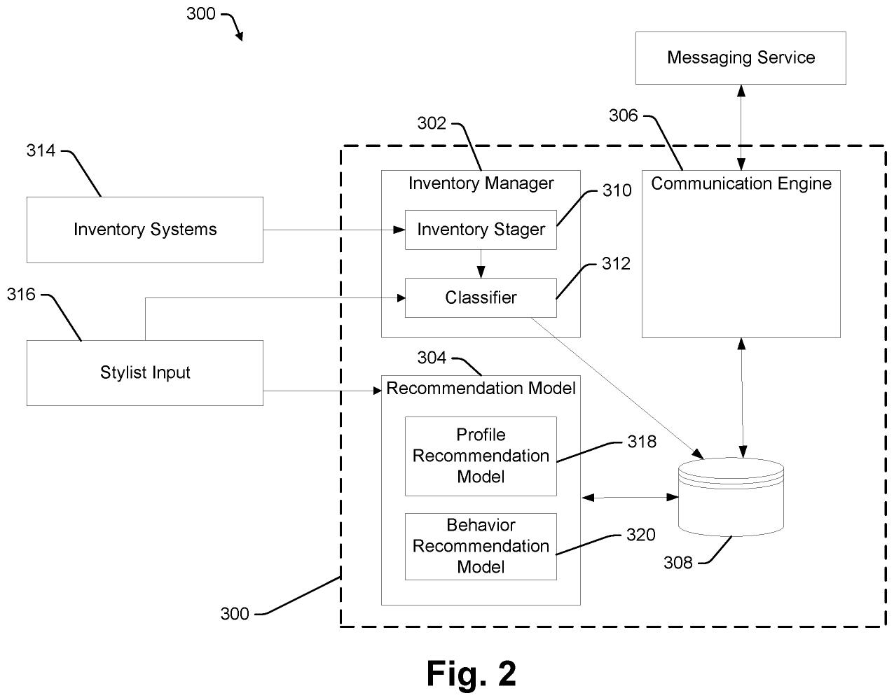

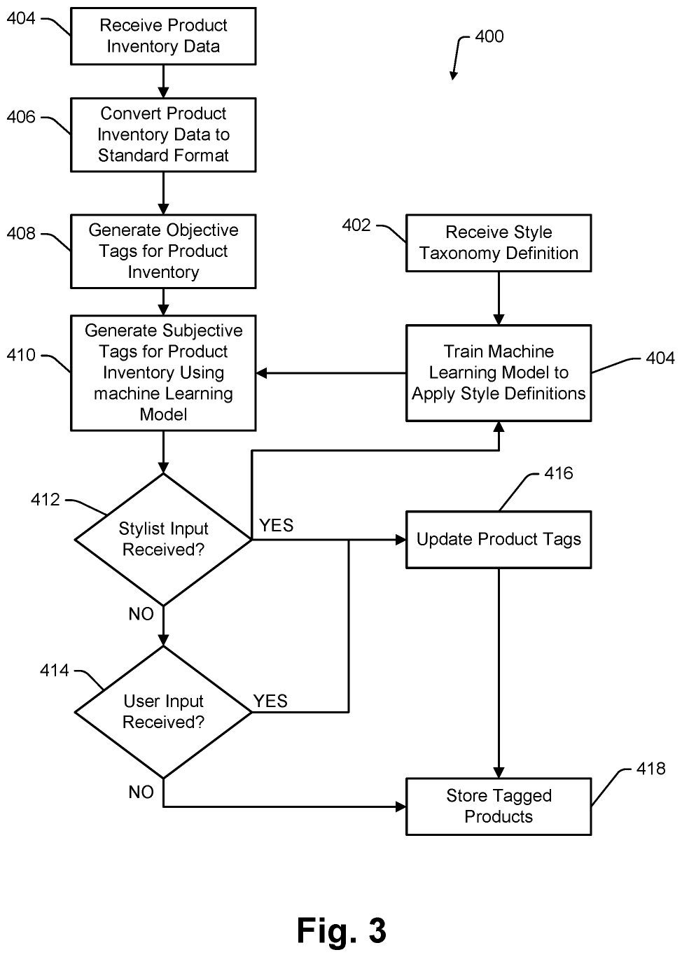

As described below with respect to FIGS. 2 and 3 inventory data received at the recommendation engine 200 can be processed at the one or more computer systems 202 to determine information of individual products of the inventory, and perform classification of the products, including, for example, by applying tags to each product. In some cases, machine learning models can be used to identify attributes of each product (e.g., clothing items 106, 112, 114). Attributes can be identified in a file of the product, from metadata of the product, or through image analysis of the product. In some cases, tags applied to products can include objective attributes of the particular product. For example, each of the clothing items 106, 112, 114 can be analyzed, and can be assigned tags relating to the fabric attributes of the given item 106, 112, 114, the neckline type, a fit of the item 106, 112, 114, and the like. Subjective tags can also be applied to products within a recommendation engine. For example, in some cases, stylists can define one or more style “buckets” (e.g., athletic wear, casual, vintage streetwear, retro, etc.). These buckets can be arbitrarily defined, as described below, and a recommendation engine can utilize machine learning (e.g., logistic regression) to apply a style bucket tag to individual products, based on the definitions provided by the stylist. The one or more computing systems 202 can store the tagged products in the database 204 upon completion of classification of the products.

In some embodiments, tags can be manually overwritten or applied by administrative users of the system (e.g., stylists). For example, as further shown in FIG. 1, the recommendation engine can provide an administrative interface 120 (e.g., a graphical user interface (“GUI”), an API, a command line interface, and the like) for administrative users to view tags assigned to products. The administrative interface 120 can be accessed from a computing device 122 of the administrative user (e.g., a computer, a virtual computer, a tablet, a mobile device, a head-mounted display, and the like). As shown, the administrative interface can display information of the products 106, 112, 114. The information can include a first style bucket 124 (i.e., “Style type 1”) associated with the first clothing item 106, a second style bucket 126 (i.e., “Style type 2”) associated with the second clothing item 112, and a third style bucket 128 (i.e., “Style type 3”) associated with the third clothing item 114. The style buckets 124, 126, 128 can be represented by tags, and can have been assigned to the corresponding clothing items by an algorithm (e.g., a machine learning algorithm) running on the one or more computing systems 202. A user of the administrative interface 120 (e.g., a stylist) can change the style bucket associated with a given product, and the updated style bucket for the item can be stored in the data store 204. In some cases, input received at the interface 120 from a user can be used to train classification machine learning models (e.g., as implemented by the one or more computing systems 202) to allow the machine learning models to classify products more accurately.

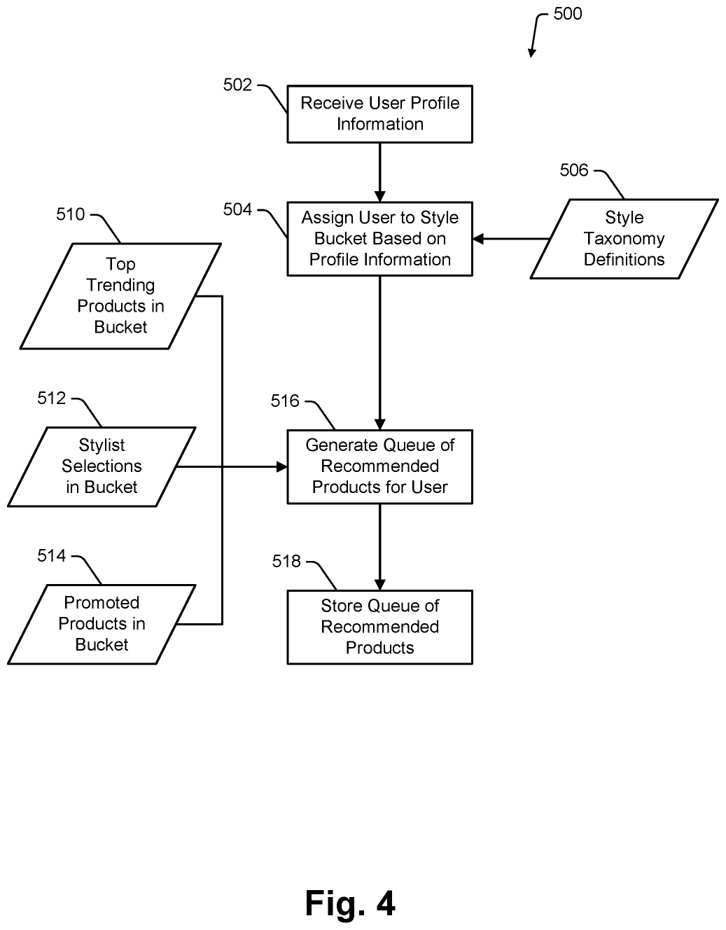

Product classifications can be used to provide tailored recommendations to consumers, which can increase sales volumes and allow online sellers to better identify their markets. For example, a recommendation engine may determine style profiles for a user and can recommend products to the user matching the style profile (e.g., products tagged with style buckets matching a determined style bucket of the user). For example, FIG. 1 further illustrates a mobile device 130 (e.g., a cell phone) of a first user. As described further below with respect to FIGS. 2 and 4, the recommendation engine 200 can access information of the first user to determine a style bucket of the first user. For example, in some cases, the first user can provide information regarding style preferences to the recommendation engine (e.g., by signing up for an account) and the user can be categorized into a particular style bucket based on the style preferences. The user can provide messaging information to the recommendation engine (e.g., a phone number, an email address, a messaging address for one or more messaging applications, a handle, etc.) to receive recommendations from the recommendation engine. In a preferred embodiment, the first user provides a phone number, and the recommendation engine can send the first user recommendations using simple messaging service (“SMS”), multimedia messaging service (“MMS”), or other communications protocols suitable for text messaging.

For example, in the illustrated embodiment, a messaging application 132 is shown on the mobile device 130. In some cases, the messaging application can be any messaging application that is operative to receive and send SMS and MMS messages and can be addressed from a user phone number. In some cases, the messaging application can be any application capable of sending and receiving messages including social media messaging applications, email messaging applications, encrypted messaging applications, and the like. In the illustrated embodiment, the recommendation engine 200 can assign the user to “Style Type 3” (e.g., based on the user's preferences), and the recommendation engine can send a first message 134 to the first user including a recommendation for the first clothing item 106. The recommendation engine 200 can decide to send the recommendation for the first clothing item 106 based in part on a match between the style bucket of the first clothing item 106 (e.g., “Style Type 3”) and the assigned style bucket of the first user. While in the illustrated embodiment, only one product (e.g., clothing item 106) is shown in the style bucket for “Style Type 3”, a style bucket can include a plurality of products (e.g., hundreds of products, thousands of products, millions of products, etc.). Further, the recommendation engine 200 can compile a queue of products for an individual user based on the style bucket of the user and other attributes (e.g., size, location, historical data of the user, etc.).

The first message 134 can include an image of the clothing item 106, and at least a portion of the message 134 can be interactive (e.g., clickable or selectable). In some embodiments, a recommendation message can further include any of the following information, alone or in combination: a product identifier, product image, URL, link, product description, and product price. Selection of the product by the first user can redirect the user to a web location at which the user can view or buy the clothing item. For example, the message 134 can include a URL link that, if clicked, directs to user's device 130 to and land on a website page which is that specific product page or a page showing the product and a number of similar, related, or even unrelated products (e.g., online storefronts 142 or online storefront 152). The website may be hosted by the brand name company, manufacturer or retailer which provided the product information and metadata from. In some cases, the recommendation engine 200 can record and store information on user engagement with the first message (e.g., clicking the message, viewing a web page for the product, and/or buying the product) and the engagement can be used to further tailor recommendations for the user.

In some cases, a user can provide a reaction to a particular message in a messaging application. As an example, the iMessage® application allows users to provide a “Tapback,” through which a user can select a visual element to indicate a reaction to the message. In some cases, Tapback reactions can be provided in the form of a Heart, Thumbs Up, Thumbs Down, HaHa, Exclamation Point, or Question Mark. Additional forms of reactions, aside from Tapback reactions, may be received and processed by a recommendation engine, such as words, numbers, symbols and combinations thereof.

In some cases, use of a Tapback reaction (or other similar reactions) can be indicative of a user sentiment or preference for the item in the recommendation message being reacted to. For example, a user can select a “thumbs up” icon to indicate that the user “likes” the message, a “heart” icon to indicate the user “loves” the message, an exclamation point icon to indicate surprise or excitement, etc. In some cases, any number of icons can be selectable by a user to indicate a reaction of the user to the message. In the illustrated embodiment shown in FIG. 1, the user has reacted to the message 134 with a “heart” reaction 136 indicating that the user “loves” the recommended item 106. The recommendation engine 200 can receive the reaction 136 from the user and can store the reaction 136 with the clothing item 106. In some cases when a user sends or reacts to a message displaying a product, the reaction format is: [reaction type] “[original message]” (e.g., ‘Liked “See you tonight!’”). The reaction type portion of the message may be saved in the data store 204, and the original message portion shown above between quotation marks may be used to identify the original message, and thus the product, the reaction pertains to. In certain embodiments, the use of SMS structure allows for translation of recommendations and reactions across several mediums using a database layer. Preferably each text (e.g., message 134) sent to a user has a standard format: [a branded domain]/[UID]M[Text ID], (e.g., https://my.qatchcode.com/12M123456). The response from the user may then look something like: Loved “https://my.qatchcode.com/12M123456”. Accordingly, the data structure itself, combining the reaction, the brand's link, the user's unique ID and the text's unique ID is unique. In some cases, a user can provide a negative reaction (e.g., a dislike), and the negative reaction can similarly be stored in the data store 204 and used to further tailor recommendations for the user. In some cases, a user can react to a recommendation message with a message indicating a user's reaction to the recommended product, rather than using a Tapback or other iconic reaction system, which may be specific to a given messaging application. Further, a user can change a reaction to a given product (e.g., by selecting a different Tapback reaction than previously selected). Upon a change of reaction, the recommendation engine 200 can receive the updated reaction and store the updated reaction in the data store 204.

A recommendation engine can refine a user's style preference over time based on user behavior, which can include user reactions to recommended products (e.g., reaction 136). For example, a positive or negative reaction to a recommended item may indicate that a style bucket for the user is different than a style bucket assigned to the user based on expressed preferences of the user. The “heart” reaction 136 to the recommended first clothing item 106 may be received at the recommendation engine 200, and a machine learning model implemented at the one or more computer systems 202 can update a style bucket for the user, and subsequently add clothing items or products from other style buckets into a queue for the user. In some cases, the computer system 202 can determine predicted reactions for clothing items of the user, based in part on previous reactions, and can add clothing items to a user's queue to be recommended to the user if the computer system 202 determines that a predicted reaction is positive. In the illustrated embodiment, clothing item 114 is assigned to a style bucket “Style Type 2,” which is different than the initial style bucket “Style Type 3” to which the user was assigned. However, the computer system 202 can determine, based on behavior of the user (e.g., interaction with recommendation messages, interaction at an online storefront, order history, and the like) including the reaction 136 to the first recommendation message 134 that the user is likely to respond positively to a recommendation for the clothing item 114. The recommendation engine 200 can send a second message 138 to the user including the second clothing item 112. The user can decide to react to the second recommendation message 138, including with a “thumbs up” reaction 140, and the recommendation engine can receive the reaction 140 and update a style bucket of the user similarly as described for reaction 136. While only two messages are shown in the illustrated embodiment, a recommendation engine is not limited with respect to a number of recommendation messages to send to a user. In some cases, recommendation messages can be sent on a set schedule, or on occurrence of a particular event (e.g., sales events, product launches, etc.), or can be sent when the recommendation identifies a product to which the user is predicted to respond favorably.

In some cases, a recommendation engine can provide a corresponding online storefront through which a user can view and purchase items. An online storefront of a recommendation engine can be customized for a given user to present items that the recommendation engine has associated with a style preference of the user (e.g., in the style bucket assigned to the user). If a user has reacted to a product (e.g., a clothing item), the online storefront can display the reaction of the user to the product. In some examples, a user can further react to products through the online storefront. For example, as illustrated in FIG. 1, an online storefront 142 can be accessed by the user at a computer device 144. The computer device 144 can be any device capable of displaying an online storefront to a user including a laptop, a desktop computer, a gaming console, a mobile phone, a head-mounted display, etc. While, in the illustrated embodiment, the computer device 144 is shown as a separate device from the mobile phone 130, the storefront 142 can be accessed from any computer device, including, for example, the mobile phone 130.

The online storefront 142 can display, to the user, curated products 146 that the recommendation engine 200 has generated based on the user's style preferences and/or engagement with products. In the illustrated embodiment, the curated products 146 includes three clothing items 106, 112, 114, but one of ordinary skill in the art will appreciate that curated items presented at an online storefront can include any number of curate items. Recommended products 106, 114 can be included in the curated products 146 and can be displayed at the online storefront 142 to the user. Further, if the user has reacted to a product recommended to the user at a messaging application (e.g., at recommendation messages 134, 138), the online storefront can display the reaction to the user at the online storefront. For example, as shown, the user provided the “heart” reaction 136 to the recommendation message 134 recommending clothing item 106, and the online storefront 142 can display the clothing item 106 with a heart icon 148 corresponding to the “heart” reaction 136. Similarly, the online storefront 142 can display the clothing item 114 with a “thumbs up” icon 150 corresponding to the thumbs up reaction 140 received from the user in response to the recommendation message 138 recommending the clothing item 114. Additional clothing items (e.g., in addition to clothing items recommended to the user through a recommendation message) can be displayed to the user at the storefront 142. For example, the clothing item 112 is displayed on the online storefront 142. While the clothing item 112 is associated with the style bucket “Style Type 1,” the recommendation engine may determine, based in part on the reactions 136, 140 that the clothing item 112 matches an updated user style bucket, and can thus display the clothing item to the user. In some cases, recommended items on an online storefront can be arranged based on a determined likelihood of favorable reaction from a user. In some embodiments, products can be arranged according to agreements with entities (e.g., entities 102, 108) to prioritize particular items.

In certain embodiments, the user may be automatically identified at an online storefront (e.g., online storefront 142). For instance, if the user clicks on or otherwise selects a URL in a recommendation message (e.g., recommendation messages 134, 138) the URL can cause the user device to show the product's webpage (e.g., at online storefront 142, 152). In other embodiments, the user may enter an identifier, such as a phone number, name, address, account number, password, or other identifier to allow the website to access the user's information and prior interactions.

Recommendation information from a recommendation engine can be used by other entities to provide targeted recommendations for their consumers. For example, as illustrated in FIG. 1, the second entity 108 can operate an online storefront 152 for selling products of the second entity 108. The second entity 208 can access the recommendation (e.g., directly through an API, or through a “widget” provided for integration with the online storefront). In some examples, the online storefront can automatically display curated content to a user if the recommendation engine 200 has established a style profile for the user. The curated content of the second entity 108 can include only products from the second entity's inventory (e.g., items in the data store 110). In some cases, if a user has reacted to a product recommendation message (e.g., messages 134, 138) from the recommendation engine, the second entity 108 can receive information about the reaction and can display the reaction with the product. For example, in the illustrated embodiment, the online storefront 152 is displaying a sales page for the clothing item 114, and a thumbs up icon 154 is displayed with the clothing item 114, corresponding to the thumbs up reaction 140 provided by the user to the recommendation message 138.

If a user of the online storefront 152 is viewing a particular item (e.g., clicks through to a sales page for a given item), the online storefront 152 can present additional items to the user based on style bucket information received from the recommendation engine. For example, in the illustrated embodiment, when the user accesses the sales page for item 114, item 112 is displayed at a portion of the display, based on information from the recommendation engine 200 indicating that clothing item 112 and clothing item 114 are in similar style buckets and/or are preferred by similar users. In some cases, the online storefront 152 can receive recommendation information from the recommendation engine 200 corresponding to a particular user. In some cases, a user of the online storefront 152 does not correspond to a user of the recommendation engine, and recommendation information is not customized for the particular user.

FIG. 2 is a schematic diagram illustrating processes performed by computer systems (e.g., the one or more computer systems 202 illustrated in FIG. 1) to implement a recommendation engine 300. The recommendation engine can be similar or identical to the recommendation engine 200 shown and described in FIG. 1. As shown, the recommendation engine can include an inventory manager 302, a recommendation model 304, a communication module 306, and a data store 308. Each of the inventory manager 302, recommendation model 304, communication module 306 and data store 308 and components thereof can be implemented by one or more computer systems (e.g., servers, virtual servers, cloud computing services, etc.). In some case, one or more of the components 302, 304, 306, 308 can be defined as software stored as instructions on a memory of a computer system and implemented by one or more processors of the system.

In some embodiments, the data store is a relational database including 2 or more logical segments for tables of the database. In an embodiment, for example, the data store 308 is a PostgreSQL database. In some embodiments, the datastore 308 can be stored on a distributed database hosted on a cloud hosting platform. In a preferred embodiment, the data store 308 includes four logical segments: Inventory, Users, Engagement, and Content (e.g., web site data).

As illustrated, the inventory manager 302 can include an inventory stager and a classifier 312, which can each include processes and/or algorithms defined in software to process inventory data received from one or more inventory systems 314. In some cases, inventory systems can include inventory systems of separate entities (e.g., data stores 104, 110 shown in FIG. 1). In some cases, an inventory system can be sourced from an online inventory system associated with the recommendation engine 300 (e.g., a Shopify store of the recommendation engine). As described with respect to FIG. 1, the recommendation engine can communicate with the inventory systems through an FTP protocol to receive files and associated metadata of products (e.g., clothing items) from an inventory system. Additionally, or alternatively, a recommendation engine can receive product information using other protocols, including, for example, at an API provided by an entity, over a TCP connection, a command line interface, HTTP protocols, direct connections to a relational or non-relational database of an entity, etc. Information from the inventory systems 314 (e.g., files and metadata including information of products in inventory of the inventory systems 314) can be ingested by the inventory manager 302 and can be staged at the inventory stager 310.

The inventory stager 310 can include a software application that sources inventory data from the one or more inventory systems 314 into a staging table in a data warehouse. Staging the data can include data processing (e.g., performing an extract, transform, load (“ETL”) operation) on the data received to conform the data to a storage format, and to facilitate analysis of the data. For example, inventory may be stored in the datastore 308 within one or more tables of a database having specific fields and staging the inventory data can include identifying information in the inventory data and loading it into corresponding fields of a staging table. The stager can also process the inventory data from the one or more inventory systems 314 by performing deduplication. The output of the inventory stager can be a staging table in a data warehouse including information of products of the inventory of the inventory systems in a standardized format. In some cases, the inventory stager can be implemented as a Python application. In other embodiments, any known programming language or combination of programming languages can be used for an inventory stager. In some cases, the inventory stager can reference information residing on the data store 308 or other portions of the recommendation engine to perform staging. For example, in some cases, it can be useful to standardize clothing sizing across different brands or entities. In some cases, a first entity (e.g., a brand, a retailer, an online seller, a wholesaler, a manufacturer of clothing, etc.) can classify an item small, while another entity can classify the item as large. Thus, an inventory can reference a size conversion chart or table that includes conversion information for clothing items corresponding to different entities. Other hardcoded information can be obtained from portions of the recommendation engine 300 and can be used to process and stage data.

Based on the metadata associated with a product inventory, a process may be provided leveraging automated intelligence or other computer machine learning to tag product identifier fields with additional product attributes, thus enabling the computer method and system to be able to predict or determine which products a specific user should be presented with via SMS or other messaging. As shown in FIG. 2, the staged data (e.g., output from the inventory stager) can be provided to the classifier 312, which can apply one or more classification algorithms to the data to apply tags or other classification information to the data. In certain embodiments the classifier may be a software-based application, for instance a Python application that uses an inventory staging table prepared by the inventory stager 310 to extract a set of one or more tags for each product in the staged table. The tagging logic may handle or operate with objective tags (e.g., category, neckline, availability, fabric attributes) and subjective tags (e.g., style bucket, age range for a given product). Objective tags may be mainly identified using regex (regular expressions) and keyword searches on data of the products in the staging table.

Subjective tags may be generated for products by the classifier 312 using machine learning algorithms, including, for example, logistic regressions, random forest classifications, generative adversarial networks, etc. In some cases, the subjective tags can be applied based on arbitrarily defined categories. For example, as illustrated, the classifier can receive a stylist input 316 including definitions for one or more style buckets. For example, a stylist input can include a set of criteria for classifying a product as meeting a given style buckets. Examples of style buckets can include retro, streetwear, athleisure, punk, and the like. As noted, however, style buckets can be arbitrarily defined by stylists, and are not limited to the examples provided. In some cases, stylist input can be used to train the classification model. For example, the classification model may initially classify a product (e.g., generate a tag for the product) as fitting within a first style bucket. As stylist can review the classification (e.g., at user interface 120) and can revise the tags applied to the given product. Revisions made by a stylist to the tags of a product can be used to train the model to increase an accuracy of the machine learning model. A final set of tags and the product data may be provided to one or both of the staging table and the data store 308. In some examples, the inventory manager 302 can include an interface that can be accessed by authenticated users or entities. For example, an online retailer may desire to perform tagging operations on their inventory and can access the inventory manager 302 via an API. The online retailer may rely on style bucket definitions defined in the recommendation engine or may elect to define their own style bucket definitions. When the inventory manager is used as a service (e.g., through an API), an online retailer can receive, from the inventory manager 302 a structured table including the product inventory and tags applied to the products in the inventory. In some cases, an online retailer or other entity can provide a single product to the inventory manager 302 for classification and can receive as output subjective and/or objective tags for the product.

FIG. 3 illustrates a process 400 which can be implemented by an inventory manager (e.g., inventory manager 302 of recommendation engine 300) to apply tags to products. The process 400 can be implemented as part of a recommendation engine (e.g., recommendation engine 200 shown in FIG. 1, or recommendation engine 300 shown in FIG. 3), or can be used independently (e.g., as an “inventory as a service” offering for online retailers). At block 402, the process can receive style taxonomy definitions from a stylist or administrative user. Style taxonomy definitions can include the style criteria for categorizing a product within one or more style buckets (e.g., retro, streetwear, athleisure, casual, etc.).

At block 404, a machine learning model can be trained to receive product data and classify the product as fitting within one or more style buckets, as defined at block 404. In some cases, training the machine learning model can include receiving a list of products from a stylist within each defined category and performing linear regressions to classify other products based on the products known to meet the style definition. In some cases, training the machine learning model can include receiving input from a stylist including a definition for a plurality of products, or presenting product classifications to a stylist for confirmation or revision.

As shown, at block 404, the process 400 can receive product inventory, which can include data for one or more products in an inventory of a product seller or manufacturer. In some cases, the product inventory can be loaded manually (e.g., via a csv file, a json object, a spreadsheet, a file list, etc.) The product inventory data can be obtained via a “pull” operation, or a “push” operation, as described above. Further, while in a preferred embodiment, the product inventory is obtained through an FTP connection and protocol, any known communications protocols can be used to obtain product inventory.

At block 406, the product inventory data can be converted into a standard format. For example, ETL processes can be performed on the product inventory data to identify attributes of the product inventory and load them into a staging table of a data warehousing service (e.g., BigQuery). In some cases, deduplication can be performed at block 406 to at least partially reduce a size of storage require for the product inventory data. In some cases, the block 406 can be performed by an inventory stager (e.g., inventory stager 310 shown in FIG. 2).

At block 408, the data of the product inventory from the staging table can be analyzed to generate objective tags for particular objects. In some cases, objective tags can include values for objective attributes of an item, including a clothing category, a neckline type, availability (e.g., whether the item is in stock or out of stock and/or how many items are in stock), fabric attributes, and the like. Objective tags may be mainly identified using regex (regular expressions) and keyword searches on data of the products in the staging table.

At block 410, subjective tags can be generated based on the product inventory data. The subjective tags can include one or more style buckets for a given item, based on the style taxonomy definitions received at block 402. In some cases, the inventory data and the objective tags can be used to generate subjective tags at block 410. The subjective tags can be generated by the trained machine learning model.

At block 412, the product inventory data and the subjective tags can be provided to an administrative user (e.g., a stylist) for review. For example, a stylist can view products in the product inventory and associated tags through an administrative user interface (e.g., a stylist console which can include the interface 120 illustrated in FIG. 1. The administrative user can change a tag associated with a product if the administrative user determines that the tag was incorrectly applied (e.g., the product does not belong in the style bucket described in the tag). If the administrative user changes a tag through the interface, the updated tag and product data can be provided to the model at block 404 to refine the model based on the stylist input, and the product tags can be updated at block 406.

At block 414, the process 400 can check for user input. For example, a user can access an interface for viewing products (e.g., interface 142 shown in FIG. 1) and can manually tag items for personalized organization. The user-defined tags can be stored along with the automatically generated tags (e.g., the subjective tags generated at block 410 and the objective tags generated at block 408) and the product data in a data store at block 418 (e.g., at data store 204 or data store 308), for use by other portions and processes of a recommendation engine.

Referring back to FIG. 2, the recommendation engine 300 can include a recommendation model 304 which can further comprise a profile recommendation model 318 and a behavior recommendation model 320. In some cases, the recommendation model 304 can produce product recommendations for a user based on characteristics of the user (e.g., profile information, demographics, response to style surveys, etc.) and/or behavior of the user (e.g., reactions to recommendation messages, clicks on an online storefront, clicking through to a product of a recommendation message, product purchases, etc.).

In some cases, a recommendation engine does not have enough behavioral data of a user to produce personalized recommendations based on behavioral data. For example, if a user is a new user of the recommendation or associated services (e.g., recommendation messaging, an online storefront associated with the recommendation engine, etc.) the recommendation engine 300 may not have any behavioral information for the user. The profile recommendation model 318 can be used to generate recommendations for a user based on characteristics of a user profile until the recommendation engine 300 determines there is enough behavioral data of the user to implement a behavior recommendation model 320. The profile recommendation model can analyze aspects of a user profile and assign a style bucket to the user based on the user profile data. Products can then be recommended to the user (e.g., at an online storefront or through recommendation messages) based on products matching the style bucket of the user.

For example, FIG. 4 is a flow chart illustrating an example process 500 for implementing a profile recommendation model. At block 502, the process can receive user profile information of the user. For example, a user signing up for the service can provide demographic information which can include a geographic location, an age, a gender, one or more sizes, and other information which can be used to match the user to a style bucket. In some embodiments, the user can make selections in a style quiz upon signup (e.g., indicated style preferences between suggested clothing items).

At block 504, the process 500 can assign the user to a style bucket based on the user's profile information obtained at block 502 (e.g., demographic information and/or the quiz responses). The process can reference stylist-defined style taxonomy definitions 506 to assign the user style bucket, and the bucket for the user can be based on a match between the quiz responses of the user and the style taxonomy definitions 506. In some cases, one or more machine learning models can be used to assign user style buckets (e.g., based on historical data for user bucket definitions and corresponding performance).

At block 508 a queue of recommended products is generated for the user. The recommended products are selected from products within the style bucket assigned to the user at block 504. In some cases, determining products to include in a user's recommendation queue can include ranking products according to one or more criteria and pushing a set number of the highest ranked products into the user's queue. In some embodiments, a user's queue can be generated at least in part on one or more of top trending products within the user's style bucket, stylist selections 512 in the user's style bucket, and promoted products within the user's style bucket 514.

In some cases, top trending products 510 can be products that have a history of performing well with members in the same style bucket. Performance can be calculated based on metrics such as positive reactions, click through rate, review time or number, purchases, positive and negative reviews of products, etc. In some cases, products can be assigned a recommendation score for recommending to the user, and products within the top trending products can be weighted higher than other recommendation sources.

In some cases, recommended products to be included in a user's queue at block 508 can be products that were individually selected by stylists within the style bucket. For example, one or more stylists can select one or more products as favorites within the style bucket, and those products can be provided to users assigned to the style bucket when the profile recommendation model is used. In some cases, the “stylists” selecting the products within a style bucket as favorites can be artificial intelligence-based and can select favorite products according to machine learning algorithms.

Promoted products 514 within a bucket can be products from paying brand partners that were selected for promotion for a specific style bucket. In some cases, for example, a brand or products within the brand can be assigned a monetization score. The monetization score can be associated with aspects of a relationship with the brand partner, including, for example, an amount paid for the promotion, a length of the relationship, a volume of articles sold from the brand, etc. The monetization scores can at least partially determine which promoted items are selected for inclusion in the user's recommendation queue at block 516. Each user's queued recommendations may be an accumulation of all three of recommendation sources 510, 512, 514, and each recommendation source 510, 512, 514 may be weighted differently. For instance, top trending products 510 and stylist selections 512 may be weighted more heavily than promoted products 514. In some cases, ranking products within a bucket to be selected for a user's recommendation queue can include determination of a “satisfaction score” for each product in inventory, and ranking products within the style bucket assigned to the user at least partially based on the satisfaction score. In some cases, ranking products for inclusion can be based on a formula where the satisfaction scores for products are weighted to account for top trending product 510, stylist selections 512, and promoted brands 514. In some cases, satisfaction score can be calculated for products from any or all of reviews for the product, reactions to the product, clicks on the product, or views of the product.

The process 500 can proceed to store the user queue of recommended products at block 518, which can include writing the queue or a portion thereof to a data store (e.g., data store 204 shown in FIG. 1, or data store 308 shown in FIG. 2). In some cases, storing the recommendation queues for a user at block 518 can include writing the recommendations to rows within a database, or updating rows in a database that is accessible to other software modules of the recommendation engine for producing recommendation messages (e.g., messages 134, 138) and/or displaying the items in the user's recommendation queue on an online storefront (e.g., online storefront 142).

Returning now to FIG. 2, a communication engine 306 can be provided in the recommendation engine 300 to communicate recommended items (e.g., items added to the user's recommendation queue by the recommendation model 304) to a user through one or more means. The communication engine 306 can at least partially determine which recommended products within the user's queue are provided to the user in a recommendation message (e.g., a SMS or MMS message at a user device), and which recommended products within a user's queue are posted to an online storefront (e.g., online storefront 142 shown in FIG. 1). In some cases, all or a portion of the communication engine 306 may be provided in any suitable programming language or format, for instance, a Python application, and is preferably operable to post new recommendations to a Content segment of the database (for instance by creating new entries in stylists_styles table) or as an SMS/MMS or other suitable communication. In some cases, the communication engine 306 can interact with one or more external service (e.g., via API) to communicate with a user via a SMS/MMS. In an example, the communication engine can interact with multiple external services to generate a body of a message (e.g., a link generation service, a messaging service, cloud database services, etc.). In some cases, the communication engine can include a scheduler engine that can interact with the data store 308 to send recommendation messages to a user (e.g., by reference to an outbound_texts table of the data store 308). In some embodiments, the communication engine can analyze or process reaction data received from a user device and can store all or a portion of the reaction data in the data store 308.

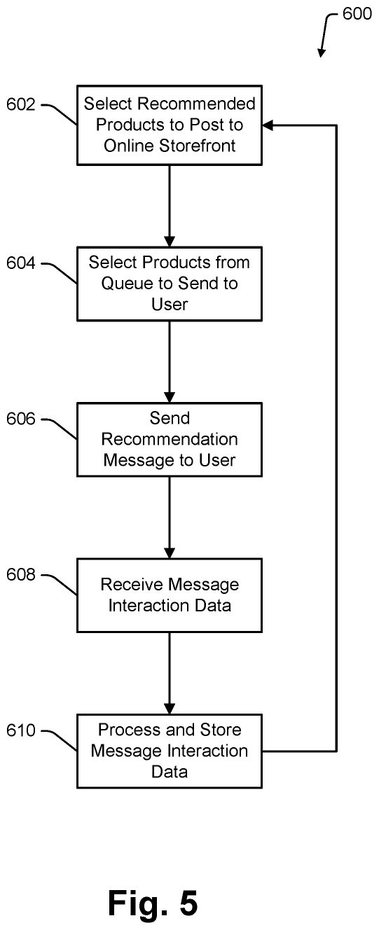

FIG. 5 is a flow chart illustrating an example process 600 for communicating product recommendations to a user. In some embodiments, all or a portion of the process 600 can be performed by a communication engine of a recommendation engine (e.g., communication engine 306 shown in FIG. 2). At block 602, the process can select recommended product to post to an online storefront for a given user. The recommended products can be selected from a recommendation queue of the user generated by a recommendation engine (e.g., the recommendation queue stored at block 518 in FIG. 4). Selecting a product from the queue to post to the online storefront can include calculating a parameter for one or more products in the queue and ranking the one or more products in the recommendation queue by that parameter. In some cases, posting a product to an online storefront for a user can include creating a row in a table of a database (e.g., in a Content segment of the data store 308 shown in FIG. 2), and an online storefront can automatically reference the table of the database to display information on products stored therein.

At block 604, the communication engine can select products from a user's recommendation queue to include in recommendation messages to be sent to the user (e.g., recommendation messages 134, 138). Selecting products from the online queue to send to users can include predicting a user reaction to a product recommendation and selecting recommended product to sent to the user based on a high probability of a favorable reaction from the user. In some cases, predicting a user reaction to a recommended product and/or selecting the product to be sent to the user can include the use of logistic regression or machine learning algorithms to determine a likely response of the user. In some cases, an entry can be created in a table of a database including information of recommendation messages to be sent (e.g., a row can be created in an outbound_texts table of the data store 308).

At block 606, the process 600 can send the recommendation message to the user. The recommendation message can be sent using SMS, MMS, or other messaging protocols. In some cases, sending the message can include providing all or a portion of the message body to a messaging service (e.g., at an API of the messaging service, which can be Twilio®, for example). In some cases, sending the recommendation message can include receiving information from other services or APIs external to the recommendation engine. For example, a communication engine can interact with a link generation API to generate a trackable link for the body of the recommendation message to be sent. In some cases, sending the recommendation engine can include scheduling messages to be sent at predetermined times or predetermined intervals.

At block 608, message interaction data can be received. Message interaction data can include a number of click on a link of the communication message, a total view time of the message, and a reaction of the user to a message. In some cases, reaction data can be received as a review comment with a textual indication that a user “Liked”, “Loved”, or “Disliked” a message and/or the product recommended by the message.

At block 610, in some cases, review messages generated by a user reaction to a message (e.g., a Tapback, as illustrated in reactions 136, 140 in FIG. 1) can be posted directly to the data store of a recommendation engine upon receipt (e.g., data store 308 of recommendation engine 300 shown in FIG. 2). In some cases, the review message can be received at the communication engine, which can perform analysis on the review message. In some cases, for example, the review message or data from the review message can be standardized before being stored in a data store of a recommendation engine. For example, a review message can vary depending on a messaging application used by a user, and the communication engine can perform operations on a review message received to ensure consistency across multiple messaging applications. For example, the message interaction data (e.g., the review message) received at block 608 can be in a raw message format, optionally in a json format or other suitable format, such as the native SMS or other messaging protocol format, or electronic data-based communication. Processing the review message can include parsing one or more data fields from the review message, which may include identifying or selecting only particular portions of the review message, for instance, based on the portion's position in the overall review message, or the content or format of the particular portion of the review message. In some embodiments, processing message interaction data can include identifying a user identifier which is preferably unique, for instance, based on provided information including phone number, IMEI, SIM, message identifier, IP address or any other provided identifier, such as an account name or password. In some cases, at block 610, a unique message identifier is extracted from the communication data. A transformed message including all or a portion of the parsed data and/or the user identifier can be created and stored in a database (e.g., the data store 308, shown in FIG. 2). In some cases, processing the message interaction data can include translating the communication received in the language selected by the user or the user's personal computing device into another language, such as English, Spanish, German, French, etc.

Returning to FIG. 2, in some cases a recommendation model of a recommendation engine can provide recommendations to a user based on the user's behavior. For example, as shown in FIG. 2, the behavioral recommendation model 320 can be used to provide recommendations for a user. The behavioral recommendation model 320 can include criteria for selecting between the profile recommendation model 318 and the behavioral recommendation model 320, and when the criteria are met, the behavior recommendation model can be used to generate recommended products for a user's queue, as further described in FIG. 5. The behavioral recommendation model can implement machine learning techniques to identify products to recommend to a user based on a user's behavior, which can include text-based reactions to recommendation messages (e.g., reactions 136, 140 shown in FIG. 1). In some cases, the behavioral recommendation model can predict user reactions for one or more products, and the prediction can at least partially determine which products are loaded into the user's recommendation queue, and which products are pushed to the user through a recommendation message (e.g., a text message).

As noted above, the recommendation engine 300 can use the profile recommendation engine 318 to provide recommendations for products to a user based on the user's profile information (e.g., demographic information, user preference information, responses to one or more style quizzes, etc.) when the recommendation engine 300 does not have enough behavioral data for the user to generate recommendations for the user based on the user's behavior. The recommendation model 304 can implement processes and algorithms for determining whether the system include enough user behavior data to switch from using the profile recommendation model 318 to the behavior recommendation model 320. In some cases, the recommendation model 304 can train a machine learning model to predict user reactions to recommended products (e.g., to predict user reactions to recommendation messages including recommendations for products) and can determine an accuracy of the model in predicting user reactions. The recommendation model 304 can switch from the profile recommendation model 318 to the behavior recommendation model 320 when the trained machine learning model meets or exceeds an accuracy score in predicting user reactions to recommendations. The behavior recommendation model 320 can implement the trained machine learning model to score and rank products and push products to a recommendation queue for the user based on prediction of the user reaction. Using each user's historical reactions and clicks as an exemplary training dataset, a behavior recommendation may predict the reaction type (loved, liked, disliked) and engagement levels for each of an entire inventory of products. Testing has revealed that the prediction accuracy for behavior recommendation models, as described in this disclosure, may be as high as 98.5%.

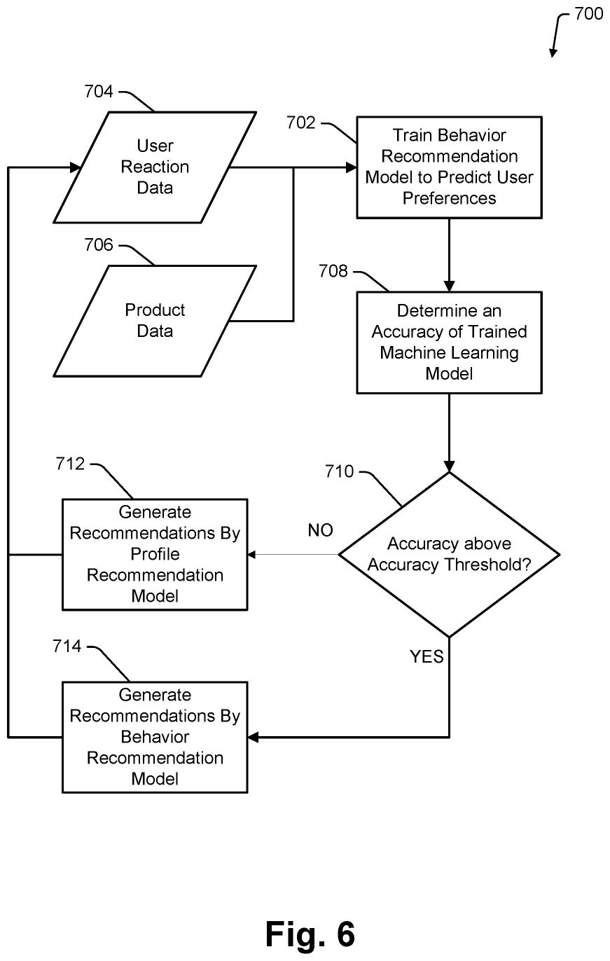

For example, FIG. 6 illustrates an example process 700 for determining whether to implement a behavior recommendation model (e.g., behavior recommendation model 320). At block 702, the process 700 can include training a machine learning model to predict user reactions to recommendation messages recommending certain products. Training the machine learning model can include receiving user reaction data 704 (e.g., from the data store 308 of the recommendation engine 300). The user reaction data can include, for example, an itemized list of SMS messages, including an SMS message unique identifier, the reaction (e.g., the Tapback) that was received for that message (including an indicator that no reaction was received, when applicable), the number of clicks that that text received (including an indicator that no click were received, when applicable), the unique identifier of the product that was displayed, all objective and subjective tags related to the product, for example category, fabric type, fabric composition, color, pattern, etc. as well as all available metadata about the product such as price, brand, product name, etc. In some cases, a portion of the user reaction data 704 can be used as a training dataset to train the machine learning model, and another portion of the user reaction data 704. The machine learning model can be validated on a validation training set comprising another portion of the user reaction data 704, and the machine learning model can be iteratively modified to achieve a desired accuracy in predicting reactions on the validation training set. In some cases, another portion of the user reaction data 704 can be used as a holdout data set, and the trained and validated machine learning model can be used to predict reactions in the holdout data set to further evaluate the accuracy of the model. The trained behavior recommendation model can be used to generate predicted reaction probabilities and product scores for products that have not yet been recommended to a user (e.g., through a recommendation message). For example, the behavior recommendation model trained at block 702 can predict individual probabilities of a message receiving a “Liked” reaction, a “Loved” reaction, a “Disliked” reaction, a number of clicks on the product. and the like. The trained behavior recommendation model can determine a predicted number of reactions for a recommendation message of a product, as well as a predicted type of reaction.

At block 708 an accuracy of the trained behavior recommendation model is determined. For example, a recommendation model (e.g., recommendation model 304) can analyze reaction data for recommendation messages in a data store and can compare the reaction data to predicted recommendation data for the product. In some cases, an accuracy score can be determined for the model based on a comparison between predicted reaction data (e.g., predicted at block 702) and reaction data received from a user for a given recommendation message. In some cases, an accuracy score is a simple percentage of recommendation messages, including a proportion of accurately predicted reactions of recommendation messages (e.g., a type and number of reaction) relative to a total number of reaction messages sent to the user. In some cases, an Area Under the Receiver Operating Characteristic Curve (“AUROC”) score can be determined to assess the accuracy of the trained behavior recommendation model. In some cases, an accuracy score greater than or equal to 0.50 can indicate that the trained behavior recommendation model is at least partially accurate in predicting user reactions.

At block 710, the accuracy of the trained machine learning model can be compared to an accuracy threshold. The accuracy threshold can be any value from 0.50 to 1.00, or greater than any of 0.60, 0.70, 0.80, 0.85, 0.90, or 0.95.

If the accuracy of the trained machine learning model does not meet or exceed the accuracy threshold, at block 712 the recommendation engine can continue to use a profile recommendation model (e.g., profile recommendation model 318 illustrated in FIG. 2). The process can receive user reaction data in response to recommendation messages based on recommendations produced by the profile recommendation engine, and the process can continually iterate, training behavior recommendation models at block 702 and evaluating the accuracy of the behavior recommendation models at blocks 708, 710 to continually evaluate if there is enough behavior data for a user to implement a behavior recommendation model.

At block 714, if the accuracy of the trained behavior recommendation model exceeds the accuracy threshold, the process 700 can utilize the trained behavior recommendation model to generate recommendations for a user at block 714. The trained behavior recommendation model can be continually tuned in response to subsequent user reactions to recommendation messages to continually customize product recommendations for users.

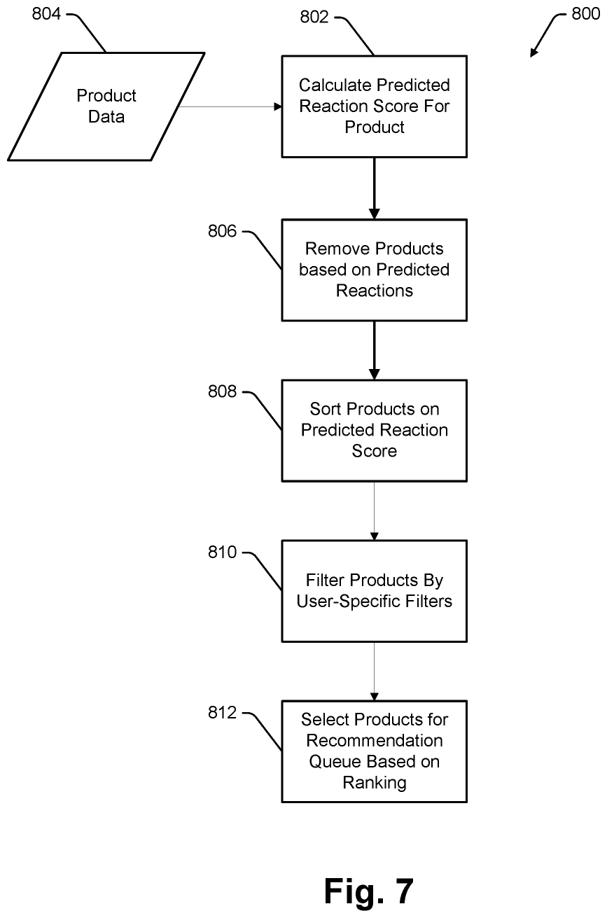

FIG. 7 illustrates an example process 800 for implementing a behavior recommendation model, according to some embodiment of the present disclosure. The behavior recommendation model may generate a selection of scored product recommendations based on reaction data (e.g., user reviews) stored in a database layer (e.g., in the data store 308 shown in FIG. 2).

At block 802, a predicted reaction score can be calculated by a trained behavior recommendation model for a product, based on product data 804. For example, the behavior recommendation model can generate predicted probabilities of reactions to recommendation messages for a given product, including a probability that a user will “Like” (e.g., select a thumbs-up via a Tapback reaction) the recommendation message, a probability that a user will “Love” (e.g., select a heart via a Tapback reaction) the recommendation message and a trained machine learning, and a probability that a user will “Dislike” (e.g., provide a thumbs-down via a Tapback reaction) the recommendation message. In some cases, the behavior recommendation model can also predict a number of click on a URL of the recommendation engine. As an example, an output of a trained behavior recommendation model can be an 80% probability that a recommendation message receives a “Loved” reaction, a 15% probability that the recommendation message receives a “Liked” reaction, and a 5% chance that the recommendation message receives a “Disliked” reaction. In some cases, the behavior recommendation model can be trained to generate probabilities for a predefined set of reactions (e.g., “Liked”, “Loved”, and “Disliked”). In some embodiments, the number of unique reactions for which probabilities can be determined can be less than three, or more than three. In some cases, machine learning techniques and algorithms can be used to determine which unique reactions to output probabilities for. In some cases, the model can be trained to translate reactions. For example, a model may evaluate an “Excited” reaction as “Loved”, and the probability generated for a “Loved” reaction can be indicative of a probability that the user will either provide a “Loved” or an “Excited” reaction to a recommendation message. A predicted reaction score for a recommendation message can comprise a value calculated from a combination of these predicted probabilities. For example, in an embodiment, a predicted reaction score (e.g., a product score) can be double the probability of a “Loved” reaction plus the probability of a “Liked” reaction minus the probability of a “Disliked” reaction.

At block 806, products can be removed from consideration for recommendation based on a predicted reaction or predicted lack of a reaction. For example, if, at block 802 a product (e.g., a recommendation message for the product) is not predicted to receive a “Loved” reaction, the product can be removed from a data set of possible products to recommend. In some cases, a product is not predicted to be “Loved” if the probability of receiving a “Loved” reaction determined by the behavior recommendation model is less than 50%. In some embodiments, a product is not predicted to receive a “Loved” reaction if the probability of receiving a “Loved” reaction (i.e., as output by the behavior recommendation model) is less than 60%, less than 70%, less than 80%, less than 90%, or less than 95%. In some embodiments, products can be removed from a data set of possible products to recommend based on another reaction (e.g., lack of a predicted “Liked” reaction). In some cases, a product can be removed from consideration for recommendation if the product is not predicted to receive either of a “Liked” or a “Loved” reaction.

At block 808, remaining product in a data set of possible products can be ranked in descending order based on the predicted reaction score determined at block 802.

At block 810, further filtering can be performed on the data set of possible products to recommend, based on user characteristics. For example, a user may set a maximum price threshold, and products can be removed from the data set if a price of the product exceeds the user-set maximum price threshold. In some cases, products can be removed if the product was any of tagged as appropriate for an age group other than the self-assigned age group of the user; tagged for a gender other than the gender requested by the user; or tagged for a sizing other than the sizing requirements requested by the user.

At block 812, the process 800 can generate a recommendation queue and send the recommendation queue to a data store of the recommendation engine (e.g., data store 308 of recommendation engine 300 shown in FIG. 2). In some examples, generating a recommendation queue can include selecting a predetermined number of the top products (e.g., as ranked by predicted reaction score) and storing the predetermined number of the top products in a recommendation queue. In some examples, the predetermined number can be up to 100 products, up to 500 products, up to 1000 products, up to 1500 products, or up to 2000 products.

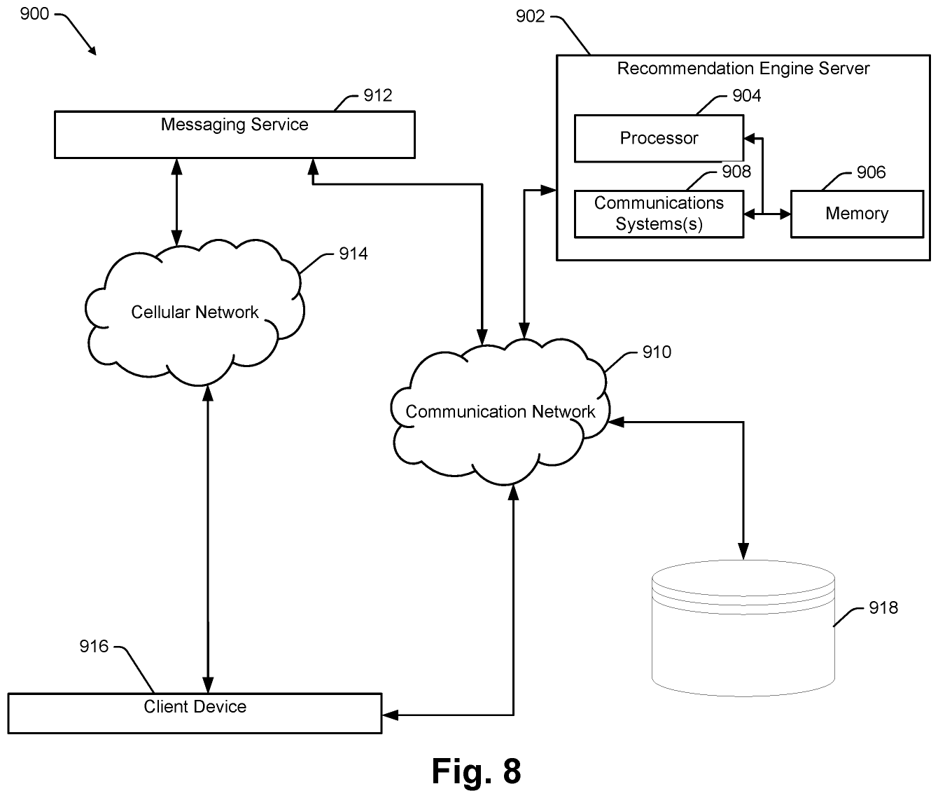

FIG. 8 illustrates an example hardware configuration for a system 900 for providing product recommendations to a user and receiving text-based reactions from the user. As shown the system can include one or more recommendation engine servers 902 (e.g., the one or more computing systems 202 illustrated in FIG. 1). The one or more servers 902 can be used to partially or wholly implement any or all of the recommendation model 304, inventory manager 302, and communication engine 306 illustrated in FIG. 2. Further, the one or more server 902 can wholly or partially execute any or all of the processes 400, 500, 600, 700, or 800 described in FIGS. 3, 4, 5, 6, and 7 respectively.

As shown in FIG. 2, the one or more recommendation engine servers can include a processor 904, memory 906, and communications systems 908. In some embodiments, processor 904 can be any suitable hardware processor or combination of processors, such as a central processing unit (CPU), a graphics processing unit (GPU), an accelerated processing unit (APU), an application specific integrated circuit (ASIC), a field-programmable gate array (FPGA), etc.

In some embodiments, memory 906 can include any suitable storage device or devices that can be used to store instructions, values, configurations, etc., that can be used, for example, by processor 904 to implement one or more processes for a recommendation engine (e.g., the one or more processes illustrated in FIGS. 3-7). Memory 906 can include any suitable volatile memory, non-volatile memory, storage, or any suitable combination thereof. For example, memory 906 can include random access memory (RAM), read-only memory (ROM), electronically-erasable programmable read-only memory (EEPROM), one or more flash drives, one or more hard disks, one or more solid state drives, one or more optical drives, etc.

In some embodiments, communications systems 908 can include any suitable hardware, firmware, and/or software for communicating information via one or more wired or wireless networks, including, for example, over communication network 910 and/or any other suitable communication networks. For example, communications systems 910 can include one or more transceivers, one or more communication chips and/or chip sets, etc. In a more particular example, communications systems 910 can include hardware, firmware and/or software that can be used to establish a Wi-Fi connection, a Bluetooth connection, a cellular connection, an Ethernet connection, etc. over a communication network 910. In some examples, communications system 908 can be in communication with the communications network 910 and can receive instructions or configurations, receive firmware or software updates, etc. In some cases, the recommendation engine server 902 can communicate information over the communication network 910 including, for example, user interfaces (e.g., online storefront 142 illustrated in FIG. 1), administrative interfaces (e.g., interface 120 shown in FIG. 1), and the like, which can be accessed from any user device 916 connected to the communication network 910 (e.g., devices 130, 144, 122 illustrated in FIG. 1). In some cases, one recommendation engine server 902 can communicate with another recommendation engine server 902 over the communication network 910 via the communication systems 908. In some cases, the recommendation engine server 902 can communicate with external services over the communication network 910 to implement a system for providing recommendation for products to users. For example, the recommendation engine server 902 can issue an API call to messaging service over the communication network 910 including instructions to send one or more recommendation messages. In some cases, the recommendation engine server 902 can communicate with a database 918 over the communication network 910 to read and write information thereto (e.g., as described with respect to data store 204 shown in FIG. 1 and data store 308 shown in FIG. 3).

In some embodiments, the messaging service 912 can communicate with the client device 916 over a cellular network 914, which can be separate from the communication network 910. For example, SMS and MMS messages can be issued from the messaging service 912 to the client device 916 and vice versa, and the messaging service can communicate messages receives from the client device (e.g., reaction messages, reviews, etc.) to the one or more recommendation engine servers 902 over the communication network 910. In some cases, the messaging service can communicate with the database 918 directly over the communication network 910 to write entries including user reaction messages and/or data.

To apprise the public of the scope of this invention, the following claims are made:

What is claimed is:

1. A method for managing product recommendations for a user, the method comprising:
receiving user data of a user of a product recommendation system, the user data including at least one style preference of the user;
determining a first style bucket for the user, the first style bucket being selected from a plurality of predefined style buckets based on the at least one style preference of the user;
selecting, from a plurality of products, at least a first recommended product, the first recommended product being selected based on one or more tags associated with the first recommended product, wherein at least one of the one or more tags is associated with the first style bucket;
adding the first recommended product to a recommendation queue of the user;
generating an instruction to send a first recommendation message to the user, the recommendation message including at least one attribute of the first recommended product, wherein the first recommendation message is one of a simple messaging service (SMS) message or a multimedia messaging service (MMS) message;
receiving a first textual review associated with a first reaction message indicating a first reaction of the user to the first recommendation message, wherein the first reaction message is one of a simple messaging service (SMS) message or a multimedia messaging service (MMS) message;
selecting at least a second recommended product based at least in part on the first textual review; and
adding the second recommended product to the recommendation queue of the user.

2. The method of claim 1, further comprising generating a first graphical user interface (GUI) accessible from a user device, the first GUI being configured to display an image of the first recommended product.

3. The method of claim 2, wherein the first GUI is further configured to display, with the image of the first recommended product, a first icon, the first icon being selected based on the first textual review.

4. The method of claim 1, further comprising:
extracting, from the first textual review, a review indicator, a unique user identifier, and a unique message identifier; and
writing, to a first database, the review indicator, the unique user identifier, and the unique message identifier, each of the review indicator, the unique user identifier, and the unique message identifier being written to a separate column of a table within the database.

5. The method of claim 1, further comprising:
receiving, from a first inventory source, a first plurality of products; and
for each product in the first plurality of products:
providing the product to a trained classification model, the trained classification model being trained to generate at least one style bucket tag for the product based on one or more attribute of the product;
generating, at the trained classification model a style bucket tag for the product and associating the style bucket tag with the product.

6. The method of claim 5, further comprising:
generating an administrative GUI configured to display at least a first product of the first plurality of products including a first style bucket tag associated with the first product;
receiving, via the administrative GUI, an instruction to change a style bucket tag of a first product from the first style bucket tag to a second style bucket tag;
associating the second style bucket tag with the first product;
adding the second style bucket tag and the first product to a training data set and;
retraining the trained classification model based on the training data set.

7. The method of claim 5, further comprising:
receiving, from a second inventory source, a second plurality of products; and
for each product in the second plurality of products:
providing the product to a trained classification model, the trained classification model being trained to generate at least one style bucket tag for the product based on one or more attribute of the product;
generating, at the trained classification model a style bucket tag for the product and associating the style bucket tag with the product.

8. The method of claim 1, wherein the first reaction comprises an iMessage Tapback.

9. A method for managing product recommendations for a user, the method comprising:
receiving user data of a user of a product recommendation system;
selecting a first style bucket for the user, the first style bucket being selected from a plurality of predefined style buckets;
selecting, from a plurality of products, at least a first recommended product, the first recommended product being selected based on one or more tags associated with the first recommended product, wherein at least one of the one or more tags is associated with the first style bucket;
adding the first recommended product to a recommendation queue of the user;
generating an instruction to send a first recommendation message to the user, the recommendation message including at least one attribute of the first recommended product, wherein the first recommendation message is one of a simple messaging service (SMS) message or a multimedia messaging service (MMS) message;
receiving a first textual review associated with a first reaction message indicating a first reaction of the user to the first recommendation message, wherein the first reaction message is one of a simple messaging service (SMS) message or a multimedia messaging service (MMS) message;
selecting at least a second recommended product based at least in part on the first textual review; and
adding the second recommended product to the recommendation queue of the user.

10. The method of claim 9, wherein the user data includes at least one style preference of the user, wherein the first style bucket is selected based on the at least one style preference of the user.

11. The method of claim 10, wherein the at least one style preference is based on at least one user response to a style quiz.

12. The method of claim 9, wherein the first recommended product is selected based on product scores calculated for each product in the first style bucket.

13. The method of claim 12, wherein the product scores are at least partially based on a satisfaction score for each product in the first style bucket.

14. The method of claim 13, wherein the product score is further calculated based on one or more of: top performing products within the first style bucket and stylist-selected products within the first style bucket.

15. The method of claim 9, further comprising generating a first graphical user interface (GUI) accessible from a user device, the first GUI being configured to display an image of the first recommended product.

16. The method of claim 15, wherein the first GUI is further configured to display, with the image of the first recommended product, a first icon, the first icon being selected based on the first textual review.

17. The method of claim 9, further comprising:
extracting, from the first textual review, a review indicator, a unique user identifier, and a unique message identifier; and
writing, to a first database, the review indicator, the unique user identifier, and the unique message identifier, each of the review indicator, the unique user identifier, and the unique message identifier being written to a separate column of a table within the database.

18. The method of claim 9, further comprising:
receiving, from a first inventory source, a first plurality of products; and
for each product in the first plurality of products:
providing the product to a trained classification model, the trained classification model being trained to generate at least one style bucket tag for the product based on one or more attribute of the product;
generating, at the trained classification model a style bucket tag for the product and associating the style bucket tag with the product.

19. A method for managing product recommendations for a user, the method comprising:
generating an instruction to send a first recommendation message to a user, the recommendation message including at least one recommended product for the user, wherein the first recommendation message is one of a simple messaging service (SMS) message or a multimedia messaging service (MMS) message;
receiving a first textual review associated with a first reaction message indicating a first reaction of the user to the first recommendation message, wherein the first reaction message is one of a simple messaging service (SMS) message or a multimedia messaging service (MMS) message;
adding the first textual review and product data of the at least one recommended product to a training data,
training the behavior recommendation model based on the training data set, the behavior recommendation model being trained to predict a reaction of a user to a recommendation message based at least in part on attributes of a recommended product included in the recommendation message;
determining an accuracy of the behavior recommendation model;
when the accuracy of the behavior recommendation model exceeds a first accuracy threshold:
generating, at the behavior recommendation model, a predicted reaction of the user to a second product;
determining that the predicted reaction of the user to the second product meets an acceptance criteria;
based on the determination that the predicted reaction of the user to the second product meet the acceptance criteria, generating an instruction to send a second recommendation message to a user, the second recommendation message including the second product, wherein the first recommendation message is one of a simple messaging service (SMS) message or a multimedia messaging service (MMS) message.

20. The method of claim 19, further comprising generating a first graphical user interface (GUI) accessible from a user device, the first GUI being configured to display an image of the first recommended product and a first icon, the first icon being selected based on the first textual review.
